(19) United States
(12) Patent Application Publication
(10) Pub. No.: US 2006/0215075 A1
(43) Pub. Date: Sep. 28, 2006

(54) Backlight Module of LCD Device

(76) Inventors: Chi-Jen Huang, Tai-Chung City (TW); Chih-Li Chang, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 10/907,183

(22) Filed: Mar. 23, 2005

(51) Int. Cl. G02F 1/1335

(52) U.S. Cl. 349/67

(57) ABSTRACT

A backlight module of an LCD device includes a plurality of fillisters formed in a reflection sheet and each of the fillisters having a reflection surface and a symmetrical axis. A plurality of point light source generators set in the fillisters, in which lights generated by the point light source generators are reflected by the reflection surfaces of the fillisters and the reflection sheet, and a profile of the point light source generators determines a shape of the fillisters. At least one diffuser plate installed on the reflection sheet for scattering the lights generated by the point light source generators and reflected by the reflection surfaces of the fillisters and the reflection sheet, in which an air space is formed between the diffuser plate and the reflection sheet.

### BACKGROUND OF INVENTION

1. Field of the Invention

The present invention relates to a backlight module of an LCD device, and more particularly, to a backlight module of an LCD device, which utilizes a plurality of point light source generators as light sources and has a reduced thickness and improved optical performance.

2. Description of the Prior Art

Liquid Crystal Displays (LCDs) are widely used in digital cameras, Personal Digital Assistants (PDAs), computer monitors, and flat panel televisions where the elimination of cathode ray tube (CRT) technology is desirable for several reasons. CRTs are characterized by large depth dimensions, undesirable weight, and fragility. Additionally, CRTs require a relatively high voltage power supply in order to sufficiently accelerate electron beams for displaying images.

In general, LCD devices have many advantages over CRT display devices in that they are thin and low in power consumption, etc. Therefore, LCD devices can effectively be substituted for CRT display devices and have been a matter of great interest in various industry fields.

In contrast to the CRT, the LCD device requires a light source, because liquid crystal is not a fluorescent material. A cold cathode fluorescent lamp (CCFL) or the like has been used as the light source of the LCD device. The lamp is included in a backlight module of the LCD device. However, the CCFL consists of mercury (Hg), which is an environmental pollutant. It is therefore desirable to replace the CCFL with a light emitting diode (LED).

Please refer to FIG. 1. FIG. 1 illustrates a structure of an LED direct type backlight module 10 according to the prior art. An LED direct type backlight module 10 includes a back-up structure 12, a printed circuit board 14, which includes a plurality of LEDs 16, situated in the back-up structure 12, a front cover 18 disposed on the back-up structure 12, a diffuser plate 20 installed on the front cover 18 for covering the printed circuit board 14, in which an air space (not shown in FIG. 1) is formed between the diffuser plate 20 and the printed circuit board 14, and a optical film 22 installed on the front cover 18 for covering the diffuser plate 20, in which an air space (not shown in FIG. 1) is formed between the optical film 22 and the diffuser plate 20.

Please refer to FIG. 2. FIG. 2 is a section view along a-a′ of the LED direct type backlight module 10 shown in FIG. 1. As shown in FIG. 2, the LEDs 16 are disposed on the printed circuit board 14 and use a surface of the printed circuit board 14 as a reflection surface. Therefore, the LED direct type backlight module 10 of the prior art utilizes a plane surface of the printed circuit board 14 to reflect lights generated by the LEDs 16.

For good mixing of red, green, and blue light, however, the LED direct type backlight module 10 of the prior art must have an increased thickness. In some prior art, two diffuser plates are used to achieve the good mixing of red, green, and blue light, but this technique decreases the brightness of the backlight module. Furthermore, the brightness uniformity of the LED direct type backlight module 10 of the prior art is bad and an LED mura will occur.

### SUMMARY OF INVENTION

It is therefore a primary objective of the present invention to provide a backlight module of an LCD device utilizing a plurality of point light source generators as light sources, and having a thinner thickness and better optical performance.

According to the present invention, a backlight module of an LCD device includes: a plurality of fillisters formed in a reflection sheet and each of the fillisters having a reflection surface and a symmetrical axis; a plurality of point light source generators set in the fillisters, wherein lights generated by the point light source generators are reflected by the reflection surfaces of the fillisters and the reflection sheet, and a profile of the point light source generators determines a shape of the fillisters; and at least one diffuser plate installed on the reflection sheet for scattering the lights generated by the point light source generators and reflected by the reflection surfaces of the fillisters and the reflection sheet, wherein an air space is formed between the diffuser plate and the reflection sheet.

It is an advantage of the present invention that the mura will not occur in the backlight module of the present invention. Additionally, the brightness and the brightness uniformity of the backlight module are improved and the thickness of the backlight module is reduced.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a structure of an LED direct type backlight module according to the prior art.

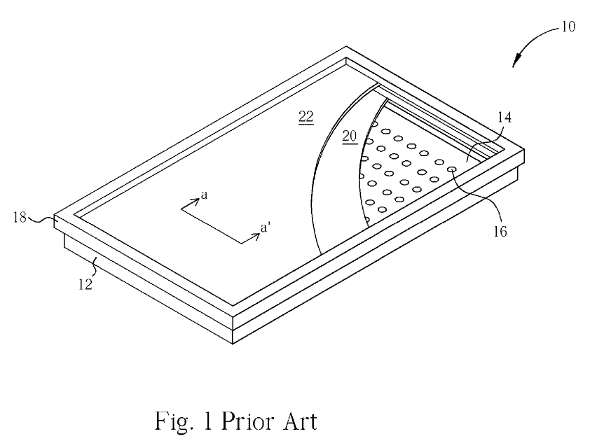

FIG. 2 is a section view along a-a′ of the LED direct type backlight module shown in FIG. 1.

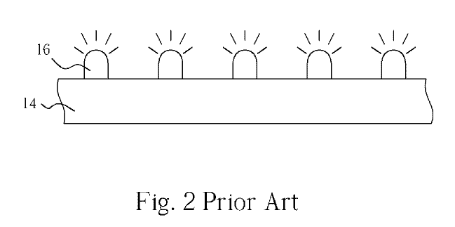

FIG. 3 is an exploded perspective diagram illustrating a backlight module of an LCD device according to a first preferred embodiment of the present invention.

FIG. 4 is a section view of the LED direct type backlight module shown in FIG. 3.

FIG. 5 shows a plurality of samples of the fillister according to the present invention.

FIG. 6 is an exploded perspective diagram illustrating a backlight module of an LCD device according to a second preferred embodiment of the present invention.

### DETAILED DESCRIPTION

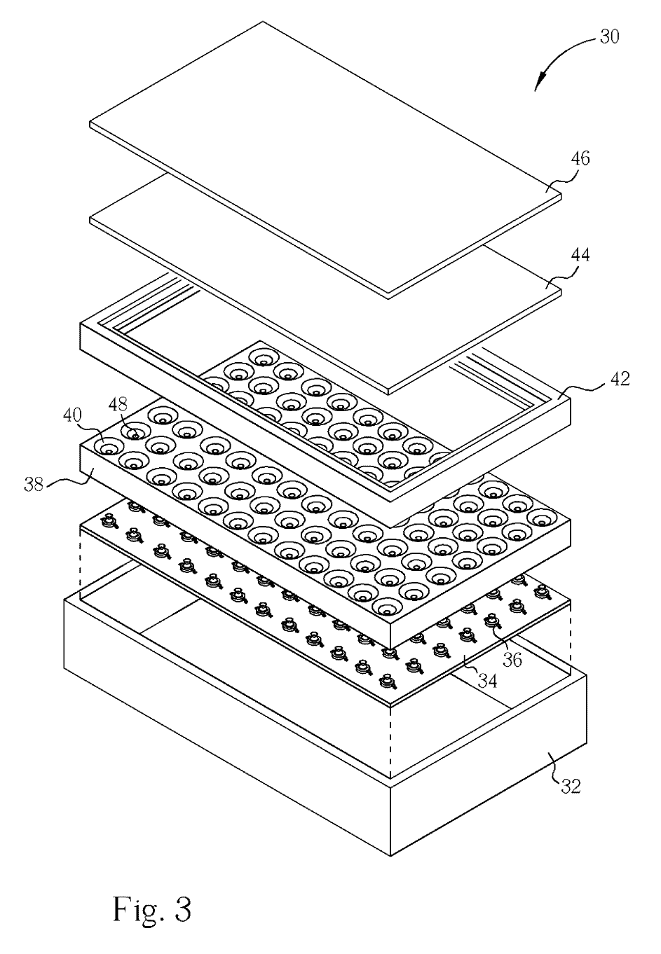

Please refer to FIG. 3. FIG. 3 is an exploded perspective diagram illustrating a backlight module 30 of an LCD device according to a first preferred embodiment of the present invention. As shown in FIG. 3, a backlight module 30 of an LCD device includes a back-up structure 32, a printed circuit board 34, a plurality of point light source generators 36 disposed on the printed circuit board 34, a reflection sheet 38, which has a plurality of fillisters 40 formed in the reflection sheet 38, a front cover 42, at least one diffuser plate 44, and at least one optical film 46. The reflection sheet 38 is fabricated by plastic injection-molding or metal injection-molding and each of the fillisters 40 has an opening 48 in the bottom of the fillisters 40. Furthermore, the fillisters 40 are arranged as an orthogonal matrix. However, the arrangement of the fillister shape reflectors 40 is not restricted to be an orthogonal matrix, and other arrangements may be applied according to the design of the backlight module 30.

When assembling, the printed circuit board 34 is situated in the back-up structure 32, the reflection sheet 38 covers the printed circuit board 34, in which the point light source generators 36 are set in the fillisters 40 through the openings 48, the front cover 42 is disposed on the reflection sheet 38, the diffuser plate 44 is installed on the front cover 42 and covers the reflection sheet 38, in which an air space is formed between the diffuser plate 44 an the reflection sheet 38, and the optical film 46 is installed on the front cover 42 and covers the diffuser plate 44, in which an air space is formed between the optical film 46 and the diffuser plate 44.

In the first embodiment, the number and position of the point light source generators 36 correspond to the number and position of the openings 48 of the fillisters 40 such that each point light source generator 36 is set in each corresponding fillister 40 one by one, and the point light source generators 36 can all generate white light or generate red light, green light, and blue light individually according to the design of the backlight module 30. In other embodiments, a point light source generator generating red light, a point light source generator generating green light, and a point light source generator generating blue light could be set together in each of the fillisters 40 for mixing the red, green, and blue lights to generate white light. A diffuser powder layer (not shown in FIG. 3) can cover the fillisters 40 for good mixing of the red, green, and blue lights.

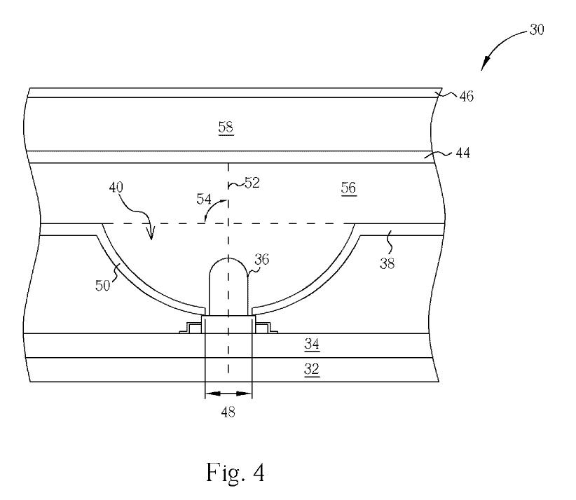

Please refer to FIG. 4. FIG. 4 is a section view of the LED direct type backlight module 30 shown in FIG. 3. As shown in FIG. 4, the printed circuit board 34 adheres to the back-up structure 32 by a glue (not shown in FIG. 4) with strong heat conduction, and heat produced by the printed circuit board 34 is radiated through the back-up structure 32. Each of the fillisters 40 formed in the reflection sheet 38 further has a reflection surface 50, and a symmetrical axis 52. An angle 54 between the symmetrical axis 52 and the reflection sheet 38 is from 85 degree to 95 degree. Moreover, the reflection surface 50 is a parabolic reflection surface. The reflection surface 50 of the fillister 40 and the reflection sheet 38 utilize a mirror reflection, and the reflection surface 50 of the fillister 40 and a surface of the reflection sheet 38 are silver-reflecting surfaces, white-reflecting surfaces, or other mirror-like reflecting surfaces. The point light source generator 36, for example, Light Emitting Diode (LED) such as side emitting LED or other similar light emitting devices for providing a stable light source to the backlight module 30, is disposed on the printed circuit board 34 and set in the fillister 40 through the opening 48, in which light generated by the point light source generator 36 is reflected by the reflection surface 50 of the fillister 40 and the reflection sheet 38. The diffuser plate 44, which may includes a plurality of scattering particles (not shown in Fig. 4) such as SiO₂ or TiO₂ for uniformly scattering the light generated by the point light source generator 36, covers the reflection sheet 38 and is used for scattering lights generated by the point light source generator 36 and reflected by the reflection surface 50 of the fillister 40 and the reflection sheet 38, and an air space 56 is formed between the diffuser plate 44 and the reflection sheet 38. The optical film 46 covers the diffuser plate 44 and an air space 58 is formed between the optical film 46 and the diffuser plate 44. It is to be understood that the backlight module 30 with one diffuser plate 44 is merely an exemplary embodiment, not a limitation. Depending on the requirements of the backlight module 30, more than one diffuser plate 44 may be used.

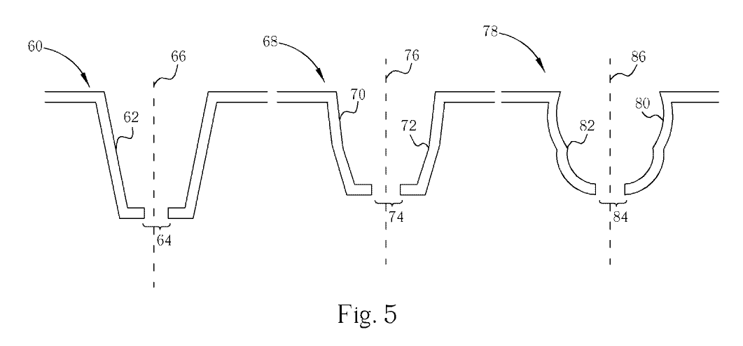

Please refer to FIG. 5. FIG. 5 shows a plurality of samples of the fillister according to the present invention. As shown in FIG. 5, a first sample of the fillister 60 has a taper reflection surface 62, an opening 64, and a symmetrical axis 66, a second sample of the fillister 68 has a taper reflection surface 70 with a bending point 72, an opening 74, and a symmetrical axis 76, and a third sample of the fillister 78 has a parabolic reflection surface 80 with a bending point 82, an opening 84, and a symmetrical axis 86. It is noteworthy that a profile of the point light source generators 36 determines a shape of the fillisters.

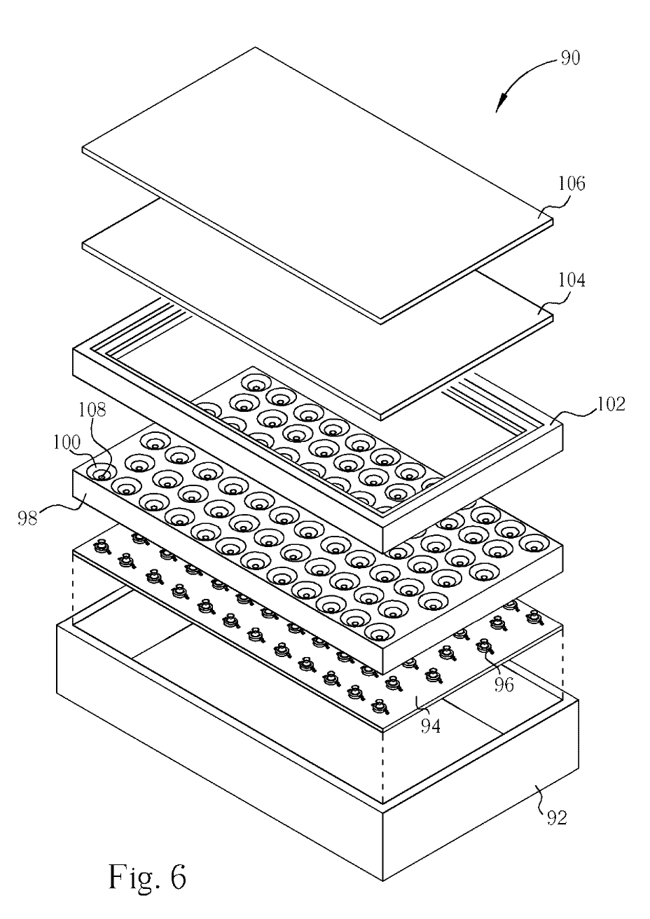

Please refer to FIG. 6. FIG. 6 is an exploded perspective diagram illustrating a backlight module 90 of an LCD device according to a second preferred embodiment of the present invention. The difference between the first preferred embodiment and the second preferred embodiment is that a plurality of fillisters 100 are arranged as a staggered matrix.

As shown in FIG. 6, a backlight module 90 of an LCD device includes a back-up structure 92, a printed circuit board 94, a plurality of point light source generators 96 disposed on the printed circuit board 94, a reflection sheet 98, which has a plurality of fillisters 100 formed in the reflection sheet 98, a front cover 102, at least one diffuser plate 104, and at least one optical film 106. The reflection sheet 98 is fabricated by plastic injection-molding or metal injection-molding and each of the fillisters 100 has an opening 108 in the bottom of the fillisters 100. Furthermore, in the second preferred embodiment, the fillisters 100 are arranged as a staggered matrix.

Compared to the prior art, because of the specific reflection structure of the reflection sheet of the present invention, the lights generated by the point light source generators passing through the diffusing plate are capable of preventing the mura while achieving better brightness uniformity of the backlight module for the condition in which the brightness of the backlight module is not decreased. Furthermore, since the backlight module of the present invention does not need a thick region for mixing red, green, and blue lights, the backlight module is thinner than other backlight modules of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module of an LCD device, comprisiA backlight module of an LCD device, comprising:
a plurality of fillisters formed in a reflection sheet and each of the fillisters having a reflection surface and a symmetrical axis;
a plurality of point light source generators set in the fillisters, wherein lights generated by the point light source generators are reflected by the reflection surfaces of the fillisters and the reflection sheet, and a profile of the point light source generators determines a shape of the fillisters; and
at least one diffuser plate covering the reflection sheet for scattering the lights generated by the point light source generators and reflected by the reflection surfaces of the fillisters and the reflection sheet, wherein an air space is formed between the diffuser plate and the reflection sheet.

2. The backlight module of an LCD device of claim 1, wherein the reflection surfaces of the fillisters are parabolic reflection surfaces.

3. The backlight module of an LCD device of claim 1, wherein an angle between the symmetrical axis and the reflection sheet is from 85 degree to 95 degree.

4. The backlight module of an LCD device of claim 1, wherein the reflection surfaces of the fillisters and the reflection sheet utilize a mirror reflection.

5. The backlight module of an LCD device of claim 1, wherein the reflection surfaces of the fillisters and a surface of the reflection sheet are silver-reflecting surfaces.

6. The backlight module of an LCD device of claim 1, wherein the reflection surfaces of the fillisters and a surface of the reflection sheet are white-reflecting surfaces.

7. The backlight module of an LCD device of claim 1, wherein the fillisters are arranged as an orthogonal matrix.

8. The backlight module of an LCD device of claim 1, wherein the fillisters are arranged as a staggered matrix.

9. The backlight module of an LCD device of claim 1, wherein the point light source generators are Light Emitting Diodes (LEDs).

10. The backlight module of an LCD device of claim 9, wherein the LEDs are side emitting LEDs.

11. The backlight module of an LCD device of claim 1, wherein a point light source generator generating white light is set in each of the fillisters.

12. The backlight module of an LCD device of claim 1, wherein a point light source generator generating red light, a point light source generator generating green light, and a point light source generator generating blue light are set together in each of the fillisters.

13. The backlight module of an LCD device of claim 12 further comprising a diffuser powder layer covering the fillisters for good mixing of the red, green, and blue lights.

14. The backlight module of an LCD device of claim 1, wherein a point light source generator generating red light, a point light source generator generating green light, and a point light source generator generating blue light are set in the fillisters individually.

15. The backlight module of an LCD device of claim 1 further comprising at least one optical film covering the diffuser plate, wherein an air space is formed between the optical film and the diffuser plate.

16. The backlight module of an LCD device of claim 1, wherein the diffuser plate further comprises a plurality of scattering particles for uniformly scattering the lights generated by the point light source generators.

17. A backlight module of an LCD device, comprising:
a back-up structure;
a printed circuit board situated in the back-up structure;
a plurality of point light source generators disposed on the printed circuit board;
a reflection sheet, having a plurality of fillisters formed in the reflection sheet, covering the printed circuit board and each of the fillisters having a reflection surface, an opening, and a symmetrical axis; and
at least one diffuser plate covering the reflection sheet, wherein an air space is formed between the diffuser plate and the reflection sheet;
wherein the point light source generators are set in the fillisters through the openings, lights generated by the point light source generators are reflected by the reflection surfaces of the fillisters and the reflection sheet, and a profile of the point light source generators determines a shape of the fillisters.

18. The backlight module of an LCD device of claim 17, wherein the printed circuit board adheres to the back-up structure by a glue with strong heat conduction, and heat produced by the printed circuit board is radiated through the back-up structure.

19. The backlight module of an LCD device of claim 17, wherein the reflection surfaces of the fillisters are parabolic reflection surfaces.

20. The backlight module of an LCD device of claim 17, wherein an angle between the symmetrical axis and the reflection sheet is from 85 degree to 95 degree.

21. The backlight module of an LCD device of claim 17, wherein the reflection surfaces of the fillisters and the reflection sheet utilize a mirror reflection.

22. The backlight module of an LCD device of claim 17, wherein the reflection surfaces of the fillisters and a surface of the reflection sheet are silver-reflecting surfaces.

23. The backlight module of an LCD device of claim 17, wherein the reflection surfaces of the fillisters and a surface of the reflection sheet are white-reflecting surfaces.

24. The backlight module of an LCD device of claim 17, wherein the fillisters are arranged as an orthogonal matrix.

25. The backlight module of an LCD device of claim 17, wherein the fillisters are arranged as a staggered matrix.

26. The backlight module of an LCD device of claim 17, wherein the point light source generators are Light Emitting Diodes (LEDs).

27. The backlight module of an LCD device of claim 26, wherein the LEDs are side emitting LEDs.

28. The backlight module of an LCD device of claim 17, wherein a point light source generator generating white light is set in each of the fillisters.

29. The backlight module of an LCD device of claim 17, wherein a point light source generator generating red light, a point light source generator generating green light, and a point light source generator generating blue light are set together in each of the fillisters.

30. The backlight module of an LCD device of claim 29 further comprising a diffuser powder layer covering the fillisters for good mixing of the red, green, and blue lights.

31. The backlight module of an LCD device of claim 17, wherein a point light source generator generating red light, a point light source generator generating green light, and a point light source generator generating blue light are set in the fillisters individually.

32. The backlight module of an LCD device of claim 17 further comprising at least one optical film covering the diffuser plate, wherein an air space is formed between the optical film and the diffuser plate.

33. The backlight module of an LCD device of claim 32 further comprising a front cover disposed on the reflection sheet, wherein the diffuser plate and the optical film is installed on the front cover.

34. The backlight module of an LCD device of claim 17, wherein the diffuser plate further comprises a plurality of scattering particles for uniformly scattering the lights generated by the point light source generators.
